(19) United States
(12) Patent Application Publication
(10) Pub. No.: US 2006/0050026 A1
(43) Pub. Date: Mar. 9, 2006

(54) Electron emission display apparatus for preventing irregular pattern of brightness

(76) Inventor: Duck-Gu Cho, Suwon-si (KR)

Correspondence Address: MCGUIREWOODS, LLP, 1750 TYSONS BLVD, SUITE 1800, MCLEAN, VA, 22102, US

(21) Appl. No.: 11/213,913

(22) Filed: Aug. 30, 2005

(30) Foreign Application Priority Data
Aug. 31, 2004 (KR) 10-2004-0069100

(51) Int. Cl. G09G 3/22

(52) U.S. Cl. 345/75.2

(57) ABSTRACT

An EED apparatus including an electron emission display panel and a driving unit thereof that can prevent irregular patterns of brightness in a display caused by a voltage drop. The EED panel comprises an anode plate partitioned into a plurality of sections, and varying electric potentials are applied to each section from the driving unit. A maximum preset voltage is applied to a section of the anode plate, and the electric potentials applied to the other sections gradually decreases as a distance increases from the section to which the maximum preset voltage is applied.

This application claims the priority of Korean Patent Application No. 10-2004-0069100, filed on Aug. 31, 2004, in the Korean Intellectual Property Office, the disclosure of which is incorporated in its entirety by reference herein.

### BACKGROUND OF THE INVENTION

1. Field of the Invention

The present invention relates to an electron emission display apparatus for preventing an irregular pattern of brightness, and more particularly, to an electron emission display apparatus including an electron emission display panel and a driving unit thereof.

2. Description of the Related Art

A typical Electron Emission Display (EED) apparatus, as disclosed in Japanese Unexamined Patent Application Publication No. 2000-242214 “FIELD EMISSION TYPE PICTURE DISPLAY DEVICE,” includes an electron emission display panel, a panel controller, a scan driver, and a data driver. The panel controller processes image signals and outputs scan driving signals and data driving signals. The scan driver drives scan electrode lines in the EED panel based on the scan driving signals from the panel controller. The data driver drives data electrode lines in the EED panel based on the data driving signals from the panel controller.

The aforementioned typical EED apparatus has a problem whereby the brightness is not uniform in each section of in the EED panel due to voltage drops in the data electrode lines and the scan electrode lines.

### SUMMARY OF THE INVENTION

The present invention provides an EED apparatus capable of effectively preventing an irregular pattern of brightness in the EED panel caused by voltage drops in the data electrode lines and the scan electrode lines.

The invention provides an EED apparatus that includes an EED panel and a driving unit connected to the EED panel. An anode plate of the EED panel is partitioned into a plurality of sections, and the driving unit applies varying electric potentials to each section of the plurality of sections of the anode plate.

### BRIEF DESCRIPTION OF THE DRAWINGS

The above and other features and advantages of the present invention will become more apparent by describing embodiments thereof in detail with reference to the attached drawings.

FIG. 1 is a block diagram illustrating an electrode emission display apparatus according to an embodiment of the present invention.

FIG. 2 is an exploded perspective view illustrating an electron emission display panel used in the electron emission display apparatus of FIG. 1.

FIG. 3 is a cross-sectional view along a Y-axis of the electron emission display panel of FIG. 2 from the viewpoint of an X-axis.

FIG. 4 is a plan view illustrating an anode plate of an electron emission display panel of FIG. 2 and voltage application positions thereon.

FIG. 5 is a block diagram illustrating an electron emission display apparatus according to another embodiment of the present invention.

FIG. 6 is an exploded perspective view illustrating an alternative electron emission display panel used in the electron emission display apparatus of FIG. 1.

FIG. 7 is a plan view illustrating an anode plate of the electron emission display panel of FIG. 5 and voltage application positions thereon.

### DETAILED DESCRIPTION OF THE INVENTION

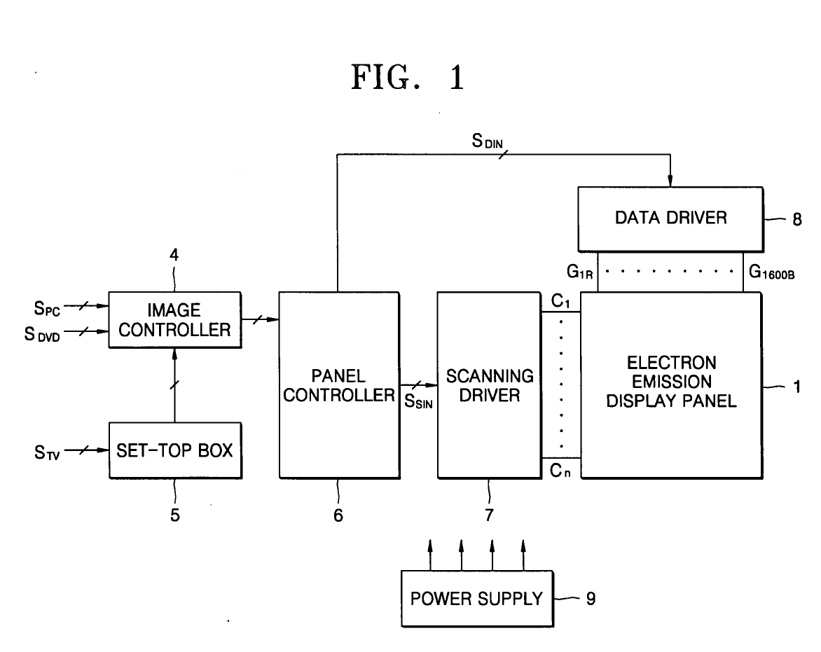

Referring to FIG. 1, an EED apparatus according to an embodiment of the present invention includes an EED panel 1 and a driving unit thereof. The EED panel driving unit includes an image controller 4, a set-top box 5, a panel controller 6, a scanning driver 7, a data driver 8, and a power supply 9.

Image controller 4 may process image signals S_{PC} from a computer, image signals S_{DVD} from a DVD player, or image signals S_{TV} from a set-top box 5 and then inputs them to a panel controller 6. Set-top box 5 converts image signals STV transmitted from a television set and then inputs them to image controller 4.

Panel controller 6 may process image signals from image controller 4 to output both scan driving signals S_{SIN} and data driving signals S_{DIN}. Scan driver 7 drives cathode electrode lines C₁ to Cₙ of EED panel 1 based on scan driving signals S_{SIN} from panel controller 6.

Data driver 8 can drive gate electrode lines G_{1R} to G_{1600B} of EED panel 1 based on data driving signals S_{DIN} from panel controller 6.

Gradation in a display can be controlled by applying varying data pulse widths to gate electrode lines G_{1R} to G_{1600B}, which are used as data electrode lines, when applying scan pulses to the cathode electrode lines C₁ to Cₙ, which are used as scan electrode lines.

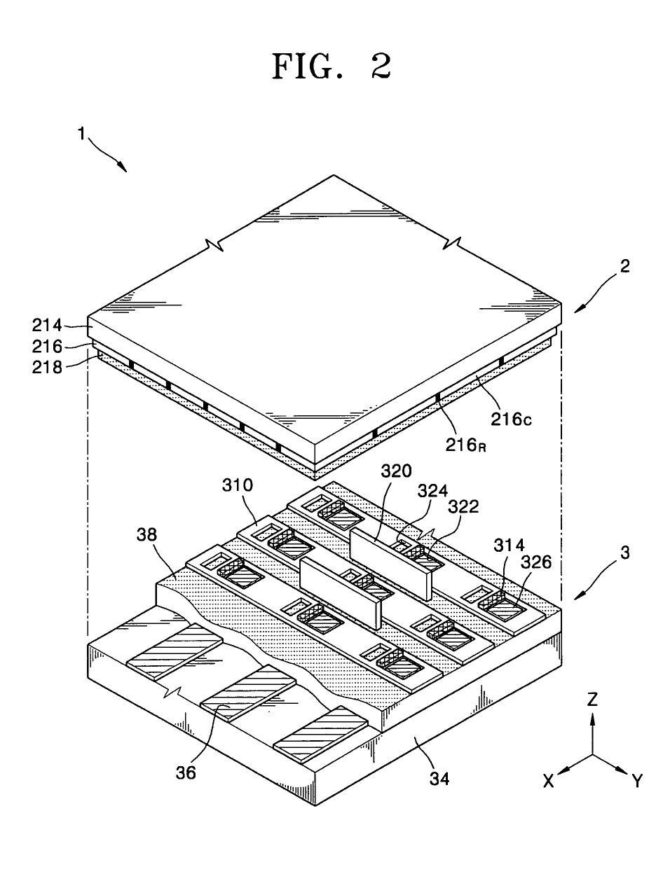

Power supply 9 supplies voltages necessary for the operation of image controller 4, set-top box 5, panel controller 6, scanning driver 7, data driver 8, and anode plate 216 (shown in FIG. 2) of EED panel 1.

A high level voltage of approximately 1 kV to 4 kV is applied to anode plate 216 that is partitioned into a plurality of sections, to which different electric potentials are applied from power supply 9. In particular, different electric potentials may be applied to each section depending on the connections between scan driver 7 and cathode electrode lines C₁ to Cₙ and the connections between data driver 8 and gate electrode lines G_{1R} to G_{1600B}. Accordingly, it is possible to effectively prevent an irregular pattern of brightness in EED panel 1 caused by voltage drops in gate electrode lines G_{1R} to G_{1600B} and cathode electrode lines C₁ to Cₙ.

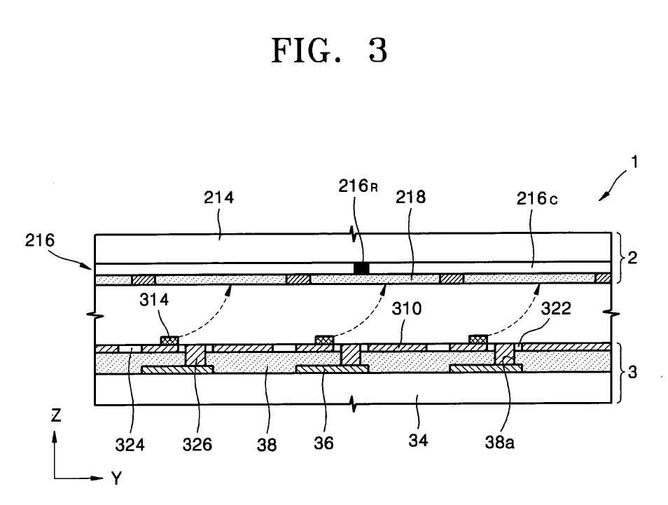

Referring to FIGS. 2 and 3, EED panel 1 includes an upper panel 2 and a lower panel 3 that are supported by a plurality of space bars 320.

Lower panel 3 includes a back substrate 34, gate electrode lines 36, an insulation layer 38, cathode electrode lines 310, and electron emission sources 314. Data signals are applied to gate electrode lines 36. Cathode electrode lines 310, to which the scan pulses are applied, are electrically connected to the electron emission sources 314.

An auxiliary window 324 is formed on one side of each electron emission source 314 in the cathode electrode lines 310. These auxiliary windows 324 are formed by removing conduction materials from cathode electrode lines 310 to expose insulation layer 8. Accordingly, stronger electric fields from gate electrode lines 36 can be applied to electron emission sources 314 through exposed insulation layer 8. For this reason, a light emission start voltage can be reduced.

Moreover, a main window 322 is formed on the other side of each electron emission source 314 and a thru-hole 38a is provided at the center of each main window 322 and extends to each gate electrode line 36. Then, counter electrodes 326 are formed by filling conduction materials into thru-holes 38a to be electrically connected to the gate electrode lines 36. In this case, since counter electrodes 326 provide additional electric fields towards electron emission sources 314, it is possible to further reduce the light emission start voltage.

Upper panel 2 includes a front transparent substrate 214, an anode plate 216, and fluorescent display cells 218. Fluorescent display cells 218 are provided to correspond with electron emission sources 314.

A high positive voltage of approximately 1 kV to 4 kV is applied to anode plate 216 so that electrons emitted from the electron emission sources 314 are moved towards the fluorescent display cells 218. In this case, anode plate 216 is partitioned into a plurality of sections 216c to permit the application of different electric potentials from the power supply 9 to each anode section. Spaces 216_{R} between each of the sections 216_{C} are filled with a material having a preset electrical resistance.

Now, anode plate 216 and its corresponding voltage application positions will be described.

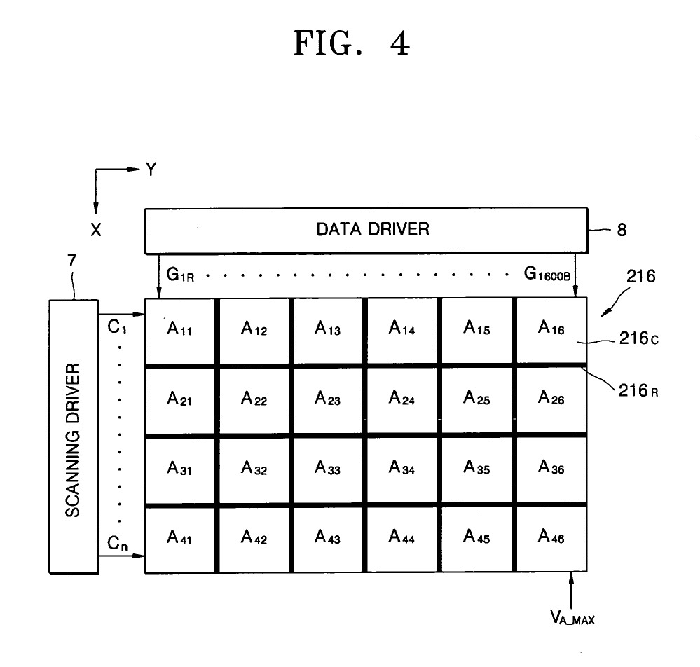

Looking at FIG. 4, cathode electrode lines C₁ to Cₙ are arranged along the X-axis and gate electrode lines G_{1R} to G_{1600B} are arranged along the Y-axis. Here, scan driver 7 is connected to cathode electrode lines C₁ to Cₙ below a first side (i.e., the left side) of anode plate 216. In addition, data driver 8 is connected to gate electrode lines G_{1R} to G_{1600B} below a second side (i.e., the upper side) perpendicular to the first side of anode plate 216.

During operation of the EED apparatus, a voltage drop may occur in the cathode and the gate electrode lines. Accordingly, a lower level driving voltage is applied to electron emission cells positioned farther from the intersection of the first and second sides (i.e., section A₁₁).

As described above, anode plate 216 is partitioned into a plurality of sections 216c (A₁₁ to A₄₆) having spaces 216_{R} disposed therebetween that are filled with a material of a preset electrical resistance.

In anode plate 216, power supply 9 applies a maximum preset voltage V _{A}_MAX to section A₄₆ at an intersection of a third side of EED panel 1 opposite the first side (i.e., the right side) and a fourth side of EED panel opposite the second side (i.e., the lower side). Different electric potentials are applied to each of the sections A₁₁ to A₄₆. More specifically, a lower positive voltage is applied to electron emission cells positioned farther from an intersection of the third and fourth sides of EED panel 1 (i.e., the lower right corner at section A₄₆). Accordingly, a higher level of driving voltage is applied to electron emission cells positioned farther from the intersection of the first and second sides of EED panel 1 (i.e., the upper left corner at section A₁₁).

Therefore, it is possible to effectively prevent an irregular pattern of brightness in the EED panel 1 caused by voltage drops in the gate electrode lines G_{1R} to G_{1600B} and the cathode electrode lines C₁ to Cₙ.

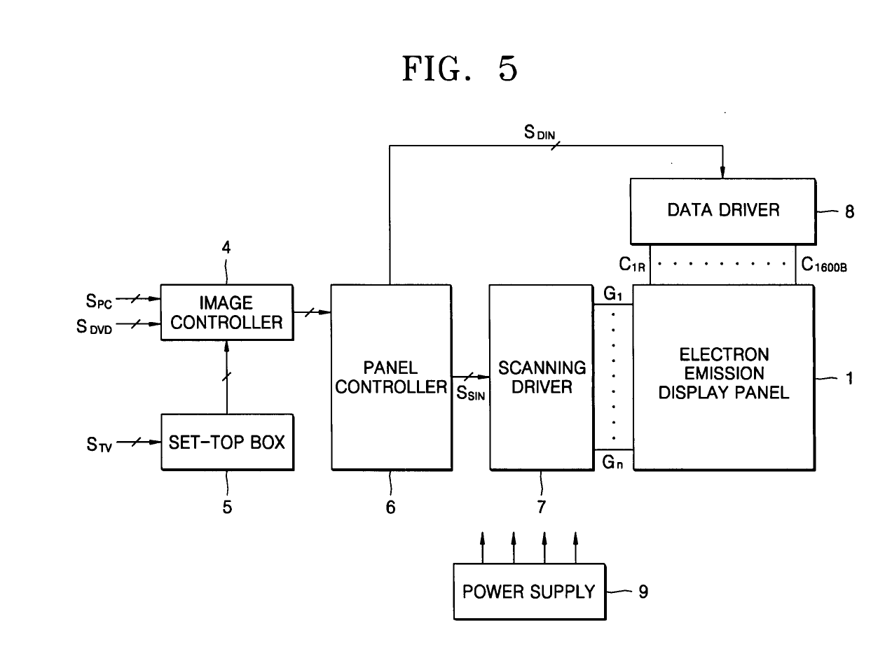

Looking at FIG. 5, an EED apparatus according to another embodiment of the present invention is similar to the EED apparatus illustrated in FIG. 1 but the scanning driver 7 drives gate electrode lines G₁ to Gₙ in the EED and data driver 8 drives cathode electrode lines C_{1R} to C_{1600B}.

Gradation in a display can be controlled by applying varying data pulse widths to cathode electrode lines C_{1R} to C_{1600B}, which are used as data electrode lines when applying scan pulses to the gate electrode lines G₁ to Gₙ, which are used as scan electrode lines.

A high level of voltage of approximately 1 kV to 4kV, is applied to the anode plate 216 partitioned into a plurality of sections, to which different electric potentials are applied from the power supply 9. In particular, different electric potentials may be applied to each section depending on the connections between the scan driver 7 and the gate electrode lines G₁ to Gₙ. Accordingly, it is possible to effectively prevent an irregular pattern of brightness in the EED panel 1 caused by voltage drops in the cathode electrode lines C_{1R} to C_{1600B} and the gate electrode lines G₁ to Gₙ.

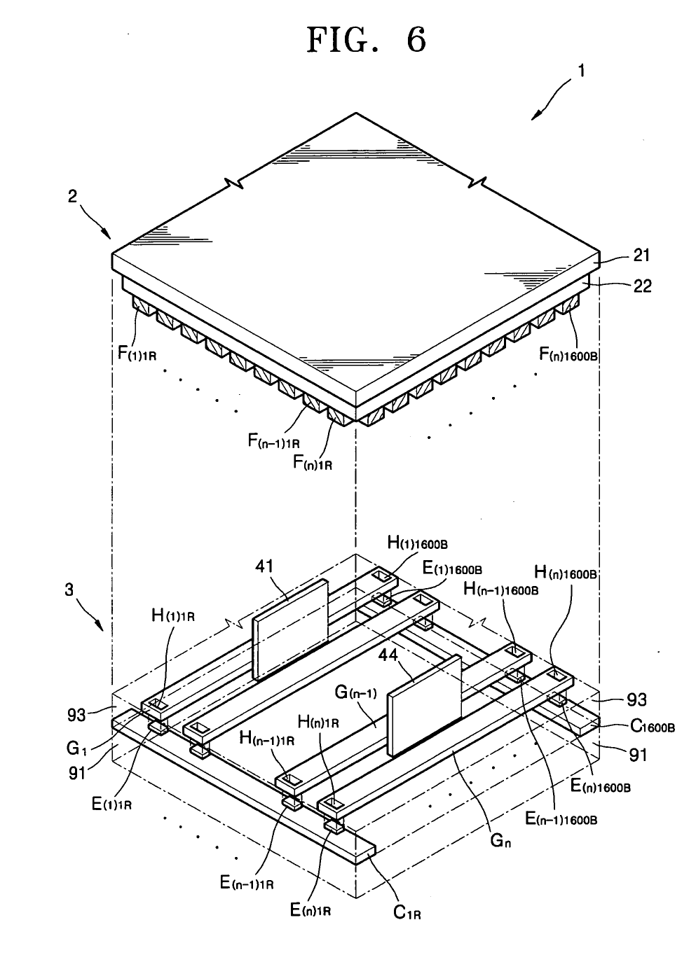

FIG. 6 shows an EED panel according to another embodiment of the present invention. EED panel 1 includes an upper panel 2 and a lower panel 3 that are supported by a plurality of space bars 41, 44.

Lower panel 3 includes a back substrate 91, cathode electrode lines C_{1R} to C_{1600B}, electron emission sources E₍₁₎ to E_{(n)1600B}, an insulation layer 93, and gate electrode lines G₁ to Gₙ.

Cathode electrode lines C_{1R} to C_{1600B}, to which data signals are applied, are electrically connected to electron emission sources E_{(1)1R} to E_{(n)1600B}. Thru-holes H_{(1)1R} to H_{(n)1600B} that correspond to electron emission sources E_{(1)1R} to E_{(n)1600B} are provided in insulation layer 93 and extend to gate electrode lines G₁ to Gₙ. Thru-holes H_{(1)1R} to H_{(n)1600B} are provided at the intersections of cathode electrode lines C_{1R} to C_{1600B} and gate electrode lines G₁ to Gₙ.

Front panel 2 includes a front transparent substrate 21, an anode plate 22, and fluorescent display cells F_{(1)1R} to F_{(n)1600B}, each of which corresponds to a thru-hole H_{(1)1R} to H_{(n)1600B} of gate electrode lines G₁ to Gₙ.

Like the previous embodiment, a high level of positive voltage of approximately 1 kV to 4 kV is applied to anode plate 22 so that the electrons emitted from the electron emission sources E_{(1)1R} to E_{(n)1600B} move towards fluorescent display cells F_{(1)1R} to F_{(n)1600B}. In this case, anode plate 22 is partitioned into a plurality of sections to which different electric potentials are applied from power supply 9. Spaces between each of the sections are filled with a material having a preset electrical resistance.

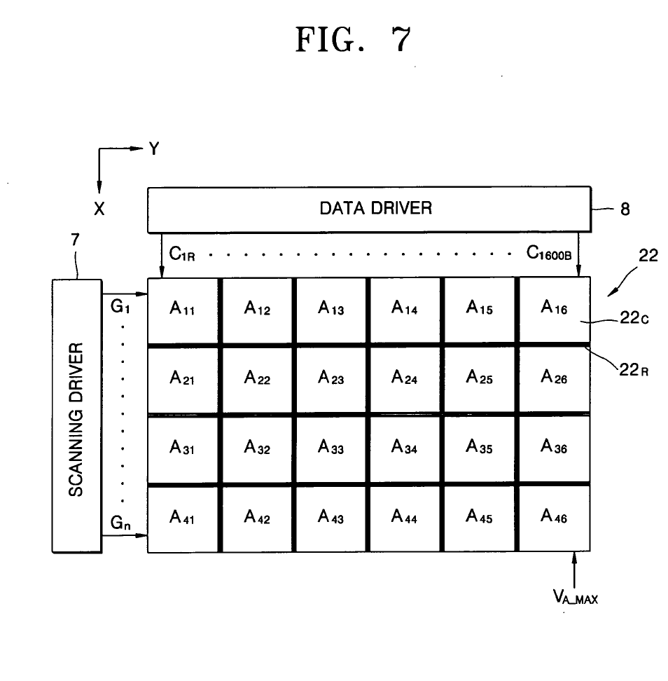

Referring to FIG. 7, anode plate 22 is partitioned into a plurality of sections 22c (A₁₁ to A₄₆) having spaces 22_{R} therebetween filled with a material having a preset electrical resistance.

As before, a maximum preset voltage V _{A}_MAX is applied to section A₄₆ and different electric potentials are applied to each of the anode sections A₁₁ to A₄₆. Then, the positive voltages applied to electron emission cells is reduced the farther such a cell is from section A₄₆. Accordingly, an irregular pattern of brightness caused by a voltage drop can be prevented.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. An electron emission display (EED) apparatus comprising:
an electron emission display panel; and
a driving unit connected to the electron emission display panel,
wherein an anode plate of the electron emission display panel is partitioned into a plurality of sections, and
wherein the driving unit applies varying electric potentials to each section of the plurality of sections of the anode plate.

2. The EED apparatus of claim 1, further comprising a material having a preset electrical resistance disposed between the sections of the anode plate.

3. The EED apparatus of claim 1, wherein the electron emission display panel 1 comprises:
electron emission sources emitting electrons to the anode plate;
cathode electrode lines arranged in parallel and electrically connected to the electron emission sources;
fluorescent display cells disposed between the anode plate and the electron emission sources; and
gate electrode lines arranged in a direction crossing the cathode electrode lines,
wherein the gate electrode lines control electric field intensities applied to the electron emission sources.

4. The EED apparatus of claim 3, wherein the driving unit includes:
a panel controller that processes image signals to output scan driving signals and data driving signals;
a scan driver driving the cathode electrode lines based on the scan driving signals;
a data driver driving the gate electrode lines based on the data driving signals; and
a power supply coupled to at least the anode plate.

5. The EED apparatus of claim 4, wherein electric potentials applied to each section of the anode plate vary according to connections between the scan driver and the cathode electrode lines and connections between the data driver and the gate electrode lines.

6. The EED apparatus of claim 5, further comprising a material having a preset electrical resistance disposed between the sections of the anode plate.

7. The EED apparatus of claim 6, wherein:
the scan driver is connected to the cathode electrode lines below a first side of the anode plate;
the data driver is connected to the gate electrode lines below a second side of the anode plate that is substantially perpendicular to the first side;
varying electric potentials are applied to each section of the anode plate when a maximum preset voltage is applied from the power supply to a section proximate to an intersection of a third side of the anode plate that is opposite the first side and a fourth side of the anode plate that is opposite the second side;
the section to which the maximum preset voltage is applied is a section furthest from a section proximate to an intersection of the first side and the second side.

8. The EED apparatus of claim 1, wherein the electron emission display panel comprises:
cathode electrode lines electrically connected to electron emission sources;
gate electrode lines having thru-holes provided in intersections with the cathode electrode lines to correspond with the electron emission sources;
fluorescent display cells provided to correspond with the thru-holes of the gate electrode lines; and
an anode plate to which a positive voltage is applied so that electrons emitted from the electron emission sources move towards the fluorescent display cells.

9. The EED apparatus of claim 8, wherein the driving unit includes:
a panel controller that processes image signals to output scan driving signals and data driving signals;
a scan driver driving the cathode electrode lines based on the scan driving signals;
a data driver driving the gate electrode lines based on the data driving signals; and
a power supply coupled to at least the anode plate.

10. The EED apparatus of claim 9, wherein electric potentials are applied to each section of the anode plate vary according to connections between the scan driver and the gate electrode lines and connections between the data driver and the cathode electrode lines.

11. The EED apparatus of claim 10, further comprising further comprising a material having a preset electrical resistance disposed between the sections of the anode plate.

12. The EED apparatus of claim 11, wherein:
the scan driver is connected to the cathode electrode lines below a first side of the anode plate;
the data driver is connected to the gate electrode lines below a second side of the anode plate that is substantially perpendicular to the first side;
varying electric potentials are applied to each section of the anode plate when a maximum preset voltage is applied from the power supply to a section proximate to an intersection of a third side of the anode plate that is opposite the first side and a fourth side of the anode plate that is opposite the second side; and
the section to which the maximum preset voltage is applied is furthest from a section proximate to an intersection of the first side and the second side.

13. The EED apparatus of claim 1, further comprising a material having a preset electrical resistance disposed between the sections of the anode plate, wherein a maximum preset voltage is applied to only one section of the anode.

14. The EED apparatus of claim 8, further comprising:
a plurality of main windows overlapping the thru-holes and corresponding to the electrode emission sources; and
a counter electrode made of a conductive material formed in the thru-hole and connected to the gate electrode line,
wherein each main window is disposed on a side of a corresponding electron emission source.

15. The EED apparatus of claim 14, further comprising a plurality of auxiliary windows corresponding to the electron emission sources, wherein each auxiliary window is disposed on a side of the corresponding electron emission source opposite the main window and thru-hole.
